(19) United States
(12) Patent Application Publication
(10) Pub. No.: US 2009/0084325 A1
(43) Pub. Date: Apr. 2, 2009

(54) Pet toy made of looped material containing catnip and a noise maker

(76) Inventor: Leah Ann Moskoff, (US)

Correspondence Address: MCDERMOTT, WILL & EMERY LLP;Attn: IP Department, 227 WEST MONROE STREET, SUITE 4400, CHICAGO, IL, 60606-5096, US

(21) Appl. No.: 12/214,049

(22) Filed: Jun. 16, 2008

Related U.S. Application Data
(60) Provisional application No. 60/997,327, filed on Oct. 2, 2007.

(51) Int. Cl. A01K 29/00

(52) U.S. Cl. 119/707; 119/28.5

(57) ABSTRACT

The present invention relates to a pet toy and/or pet body pillow containing an outer-looped fabric, facial features depicted on the fabric, an amount of catnip and other fillings within the toy, and some amount of light cord attached to the outer-looped fabric.

### REFERENCE TO RELATED APPLICATION

This application claims the benefit of the filing date of U.S. Provisional Patent Application No. 60/997,327 filed on Oct. 2, 2007.

### FIELD OF THE INVENTION

The present invention relates to a toy and/or pet body pillow for domestic pets, and, specifically, to a cat toy and/or pet body pillow comprised of a looped fabric housing catnip and a plurality of noise makers and tactile stimulants.

### BACKGROUND OF THE INVENTION

Toys are important to domestic cats and other pets because they provide a form of exercise, particularly to those pets that live indoors. Exercise from playing with a pet toy can help a cat to maintain a healthy weight and release energy or aggression in a positive way, which helps to prevent social and behavioral problems. Furthermore, interactive playing between a human and a cat strengthens the bond between the animal and its human companion, providing further health benefits. Cats are known to enjoy playing with stuffed toys. Moreover, cats are known to have an affinity toward the scent of Nepatia cataria, commonly called “catnip.” The euphoric effect of catnip upon cats is due to the inhalation of the plant's active ingredient, nepetalacetone. Accordingly, many cat toys contain catnip. However, current pet toys often fail to attract or maintain the attention of cats long enough to provide the accompanying physical and mental health benefits. This is due to the fact that current pet toys fail to fully engage many of a cat's senses, or fail to engage several of these senses at one time.

The present invention is provided to solve these limitations and to provide advantages and aspects not provided by conventional pet toys, including cat toys. A full discussion of the features and advantages of the present invention is deferred to the following detailed description, which proceeds with reference to the accompanying drawings.

### SUMMARY OF THE INVENTION

It is a primary object of the present invention to provide a novel and improved cat toy providing visual, tactile, olfactory, and auditory stimulation to cats, as well as a toy that can be utilized as a “body pillow” or comfortable resting place. As such, one object of the present invention is to provide an improved cat toy that simulates either the appearance of another cat or of an oversized rodent. Another object of the present invention is to provide an improved cat toy that is roughly of the same length as the body of a cat to allow all the cat's limbs to be engaged during play activity. Furthermore, the length, circumference, soft outer fabric and compressibility of the interior stuffing of the toy provides a cat with a body pillow or comfortable resting place when play activity is not desired. Another object of the present invention is to provide a cat toy having a soft, stuffed body with looped fabric that serves as a clawing/scratching device for the cat playing with the toy. A still further object of the present invention is to provide a novel and improved cat toy that contains catnip, preferably in a breathable pouch. A still further object of the present invention is to provide a novel and improved cat toy that provides auditory and tactile stimulation using various fillings, such as bells and crackle paper. Another, final object of the present invention is to provide a novel and improved cat toy that has at least one re-sealable closure to allow for the removal and replacement of the various fillings and catnip.

### BRIEF DESCRIPTION OF THE DRAWINGS

The advantages and novel features of the present invention will become apparent from the following detailed description of the preferred embodiments of the invention illustrated in the accompanying drawings, wherein:

FIG. 1 illustrates a front view of a first embodiment of the present invention.

FIG. 2 illustrates a rear view of the embodiment of the present invention shown in FIG. 1.

FIG. 3 illustrates a side view of the embodiment of the present invention shown in FIG. 1.

FIG. 4 illustrates a top view of the embodiment of the present invention shown in FIG. 1.

FIG. 5 illustrates a bottom view of the embodiment of the present invention shown in FIG. 1.

FIG. 6 illustrates a front view of a second embodiment of the present invention.

FIG. 7 illustrates a front view of a third embodiment of the present invention.

FIG. 8 illustrates a rear view of the embodiment of the present invention shown in FIG. 7.

FIG. 9 illustrates a side view of the embodiment of the present invention shown in FIG. 7.

FIG. 10 illustrates a top view of the embodiment of the present invention shown in FIG. 7.

FIG. 11 illustrates a front view of a fourth embodiment of the present invention.

FIG. 12 illustrates a rear view of the embodiment of the present invention shown in FIG. 11.

FIG. 13 illustrates a side view of the embodiment of the present invention shown in FIG. 11.

### DESCRIPTION OF THE PREFERRED EMBODIMENT

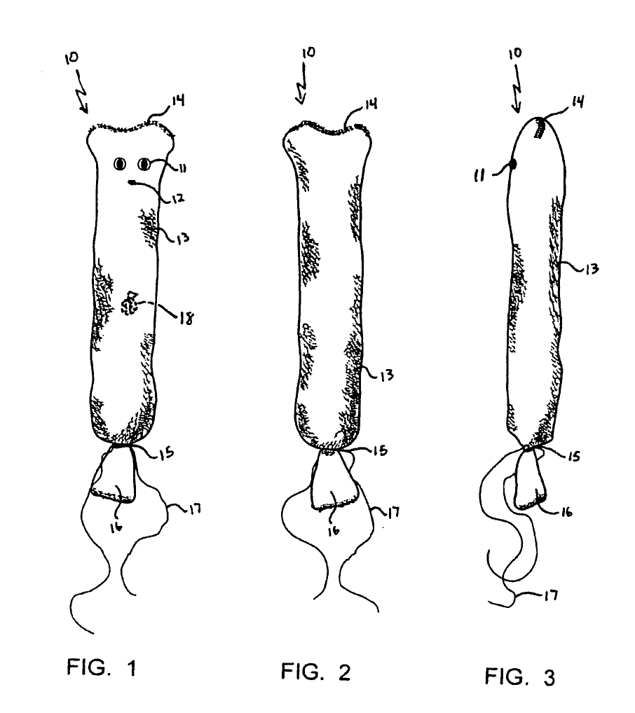

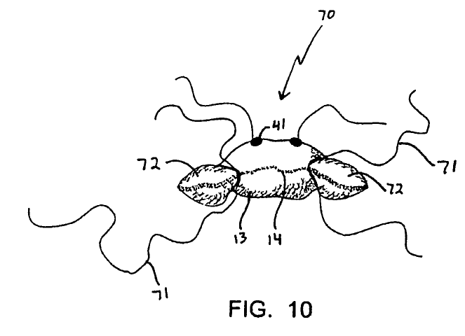

While this invention may include embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. FIGS. 1-13 illustrate several embodiments of the present invention wherein a pet toy 10, a pet toy 40, and a pet toy 70, respectively, are designed to provide several simultaneous modes of sensory stimulation and comfort to a pet, particularly a cat. These modes of stimulation may comprise visual, tactile, olfactory, and/or auditory stimulation.

Specifically referring to the embodiment of the present invention illustrated in FIG. 1, the pet toy 10 is designed to simulate the appearance of a cat. Such an appearance may provide visual stimulation to the pet, entertainment to the human companions of the pet, and can be accomplished through several devices. First, the exterior of the pet toy 10 is made of a looped fabric 13, which gives the appearance of fur. The looped fabric 13 may be colored to resemble various patterns of fur, or may be colored in a fanciful color scheme. In one embodiment, the looped fabric 13 is comprised of material made of acrylic, spandex, wool, cotton, or similar fabric and is approximately the same total length as an adult cat's body.

Second, the appearance of cat is simulated through the attachment of a pair of cat's eyes 11 and a cat's nose 12 to the looped fabric 13 near the upper portion of the pet toy 10. The cat's eyes 11 and the cat's nose 12 may be made of plastic or another durable material and may be affixed to the looped fabric 13 through the use of metal or plastic washers or backers, stitching, or an adhesive substance. In one embodiment of the present invention, the cat's eyes 11 are plastic half-spheres containing vertical, marquis-shaped pupils, thus simulating the natural appearance of a cat's eyes. In an embodiment, the cat's nose 12 is black and is formed to include nostrils, thus simulating the natural appearance of a cat's nose.

Third, the upper end of the pet toy 10 is closed at the edge of the looped fabric 13, forming a first closure 14. In an embodiment of the present invention, this first closure 14 is accomplished by sewing together the upper edge of the looped fabric 13 in such a way as to give the appearance of a cat's ears, further simulating the appearance of a cat by the pet toy 10.

Fourth, in one embodiment of the present invention, the lower end of the pet toy 10 is closed at a distance away from the edge of the looped fabric 13, forming a second closure 15. In the present embodiment, this second closure 15 is accomplished by tying a piece of sisal twine tightly around the looped fabric 13 approximately three inches from the edge as illustrated in FIGS. 1-3, 5-9 and 11-13. The hanging sisal twine 17 may be replaced by other tying implements such as rope, thread, yarn, cords, shoelaces, or other similar materials. The second closure 15 creates a tail section 16, which, in an embodiment of the present invention, corresponds to the elastic portion of a tube sock. Also, excess portions of the hanging sisal twine 17 hang down from the closure 15. Together, the tail section 16 and hanging sisal twine 17 simulate the appearance of a cat's tail. The hanging sisal twine 17 also provides additional tactile stimulation for a cat. All of these elements, both separately and in combination, allow the pet toy 10 to simulate the appearance of a cat both to the pet and the pet's human companion. Alternatively, the second closure 15 could be sewn across similar to the first closure 14. Further, an alternate embodiment of the present invention could include feet (paws) and/or a tail attached either along the body of the pet toy 10 or at the second closure 15.

As shown in FIG. 1, the pet toy 10 is also designed to provide tactile stimulation to a pet which plays with the toy. Specifically, an embodiment of pet toy 10 (illustrated in FIGS. 1-10) is intended to provide interaction for a pet with claws, such as a cat, allowing the pet to exercise its natural desire to scratch. To accomplish this objective, the exterior of the pet toy 10 is made of a looped fabric 13. In one embodiment, the looped fabric 13 is comprised of material from a tube sock turned inside-out, made of acrylic, spandex, wool, cotton, or similar fabric. During play, the cat's claws may catch on the fabric's loops. Cats are naturally driven to periodically hook their front claws into suitable surfaces and pull backwards, in order to clean the claws as well as exercise and stretch their muscles. This scratching behavior is enjoyable to cats, even cats whose claws have been surgically removed. In one embodiment, this looped fabric 13 is approximately the same total length as an adult cat's body, roughly twenty inches in total length, and approximately nine to eleven and one half inches in circumference. Although dimensions are provided herein, it should be noted that any dimensions for the pet toys described herein may be utilized that provide the advantages enumerated herein and the present invention should not be limited as described herein.

The pet toy 10, as illustrated in FIG. 1, is further designed to provide olfactory stimulation to a pet, which interacts with the toy. Together, the looped fabric 13, the first closure 14, and the second closure 15 define an interior region inside pet toy 10. To provide olfactory stimulation to a pet, this interior region may contain an aromatic substance 18 which provides an attractive or pleasing smell to the pet. In one embodiment of the present invention, this aromatic substance 18 could comprise Nepatia cataria, commonly called “catnip.” Catnip has an euphoric effect upon cats due to inhalation of the plant's active ingredient, nepetalacetone.

In one embodiment, the interior region is approximately seventeen (17) inches in height from the second closure 15 to the first closure 14. The tail section 16 may be approximately three (3) inches in length. Further, the width of the pet toy 10 may be three and a half (3.5) to five (5) inches across the top at the first closure 14. The present invention may be modified to different size dimensions. These or other similar dimensions further enhance the appeal of the pet toy 10, by enabling a pet to wrap its entire body around the toy and engage all four of its limbs in play activity. Further, pets can use the pet toy 10 as a body pillow for relaxation.

Further, these or other similar dimensions allow for a large volume of aromatic substance 18 and various fillings, such as crackle paper or bells, to be housed in the interior region of the pet toy 10. A larger volume of aromatic substance 18 will provide added olfactory stimulation to the pet and will allow a longer period of use before the properties of the aromatic substance 18 decrease in their effectiveness. Furthermore, the aromatic substance 18 may be housed in the interior region of the pet toy 10 in several manners. As illustrated in FIG. 1, the aromatic substance 18 may be housed in a breathable pouch or sack that is placed in the interior region of the pet toy 10. Alternatively, the aromatic substance could also be dispersed throughout part or the entire interior region without being housed in a sack or pouch.

The pet toy 10, illustrated in FIG. 1, is designed to provide auditory stimulation to pets, in addition to tactile stimulation. Further, the interior region of pet toy 10, defined by the looped fabric 13, the first closure 14, and the second closure 15, may also contain a plurality of fillings. In one embodiment, the filling could be crackling paper. Crackling paper could comprise a paper or wax base coated with foil or plastic, such that when crumpled into a ball, the paper makes a cracking noise. This crackling paper would act as both stuffing in the interior region, giving shape to the pet toy 10, and as a filling to provide auditory and tactile stimulation when the pet moves or compresses the toy. In an alternative embodiment, the noisemaker might comprise one or more bells, which could move about the interior region of the pet toy 10. The interior region might contain either or both of those fillings described above, or other filling elements, alone or in combination. Further, the interior region might contain other fillings, such as acrylic batting, cotton, fabric, Mylar and/or other plastic or paper materials.

FIGS. 2 and 3 provide rear and side views, respectively, of the embodiment of the present invention illustrated in FIG. 1. In one embodiment, the looped fabric 13 wraps completely around pet toy 10. From the rear of pet toy 10, neither the cat's eyes 11 or the cat's nose 12 are visible. The first closure 14 and the second closure 15 which seal the ends of the looped fabric 13 are both visible in both views of pet toy 10. The first closure 14 and the second closure 15 look substantially similar from the rear and side views as from the front view. The tail section 16 and hanging sisal twine 17 are also visible in both views to simulate the cat's tail.

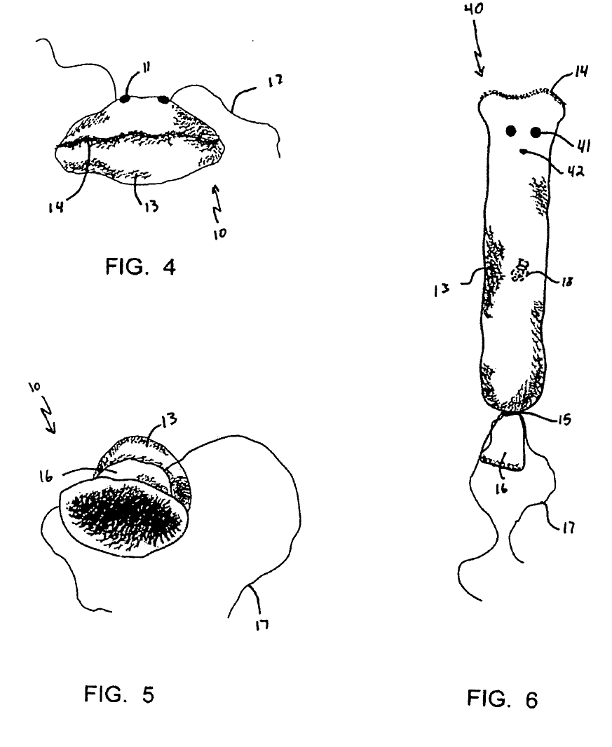

FIGS. 4 and 5 provide top and bottom views, respectively, of the embodiment of the present invention illustrated in FIG. 1. Again, in this embodiment, the looped fabric 13 wraps completely around the pet toy 10. Alternatively, the lopped fabric 13 could only cover a portion of the pet toy 10 or pet toy 10 could be made of smooth fabric that does not contain looping or any other fabric that is useful to engage a cat so that the cat will play with the pet toy 10. The top view shows an embodiment of the present invention wherein the first closure 14 simulates the cat's ears. The eyes 11 and hanging sisal twine 17 may be visible from the top view. The bottom view illustrates the tail section 16 which is formed by tying the hanging sisal twine 17 around the looped fabric 13 at the second closure 15.

An alternative embodiment of the present invention is illustrated in FIG. 6. Pet toy 40 provides many of the same stimuli in a similar fashion to the embodiments of the invention, pet toy 10, demonstrated in FIGS. 1-5, above. For example, tactile stimulation is present in the form of the looped fabric 13, the interior fillings, and the hanging sisal twine 17. Olfactory stimulation is produced through the presence of an aromatic substance 18 in the interior region of the pet toy 40. Also, the pet toy 40 can provide auditory stimulation to the pet through the use of a plurality of fillings in the interior region. However, pet toy 40 may provide visual and tactile stimulation to the pet that is different from that of pet toy 10. This is accomplished through the use of mouse eyes 41 and a mouse nose 42, as well as potentially a different coloring scheme of the looped fabric 13. These elements in combination simulate the appearance of a large rodent to a pet, such as a cat, who plays with pet toy 40. The mouse's eyes 41 and the mouse's nose 42 may be made of plastic or another durable material and may be affixed to the looped fabric 13 through the use of metal or plastic washers or backers, stitching or an adhesive substance. In the present embodiment, the mouse's eyes 41 are shaped as plastic spheres or flat circles, which are completely black, thus simulating the natural appearance of a rodent's beady eyes. The mouse's nose 42 is pink, triangular, and pointy, thus simulating the natural appearance of a rodent's nose. The other features mentioned in describing the visual appearance of the embodiment of FIGS. 1-5 may be the same as described above.

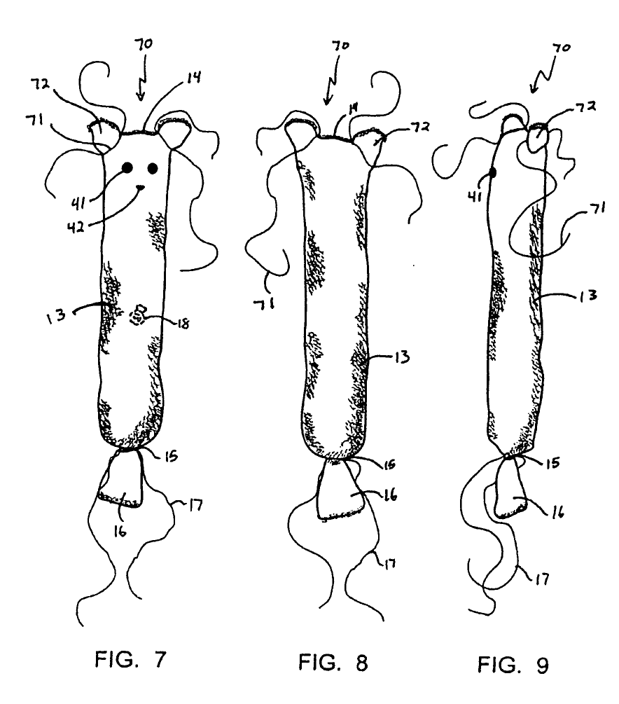

FIGS. 7-10 illustrate yet another embodiment of the present invention. FIGS. 7-10 show front, rear, side, and top views, respectively, of a pet toy 70. Pet toy 70 may be formed in similar fashion to pet toy 10 and pet toy 40, as shown in FIGS. 1-6 and described above. Tactile stimulation is present in the form of the looped fabric 13, the interior fillings, and the hanging sisal twine 17. Olfactory stimulation is produced through the presence of an aromatic substance 18 in the interior region of the pet toy 70. Also, the pet toy 70 can provide auditory stimulation to the pet through the use of a plurality of fillings in the interior region. However, pet toy 70 contains further modifications to provide visual stimulation by also simulating the appearance of an over-sized rodent. First, this is partly accomplished through the use of mouse eyes 41 and a mouse nose 42, as well as potentially a different coloring scheme of the looped fabric 13, in similar fashion to pet toy 40. Moreover, the pet toy 70 also comprises two lengths of ear twine 71 which may be tied around portions of the first closure 14. By tying off portions of the first closure 14, the ear twine 71 forms two ear sections 72 which simulate the appearance of a rodent's ears. The ears sections 72, as well as the hanging sisal twine 17, provide yet another source of tactile stimulation for the pet. The other features of visual appearance of pet toy 70, such as the hanging sisal twine 17 and tail section 16, may be similar to that of pet toy 10 and pet toy 40.

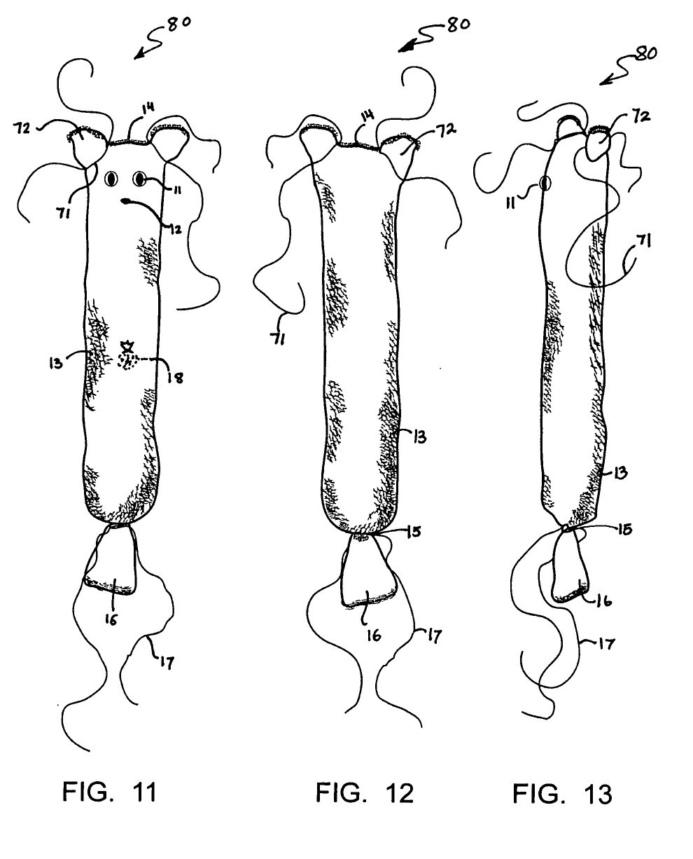

Lastly, FIGS. 11-13 illustrate yet another embodiment of the present invention. FIGS. 11-13 show front, rear, and side view of a pet toy 80. Pet toy 80 may be formed in a similar fashion to pet toys 10, 40 and 70. Tactile stimulation is present in the form of the looped fabric 13, interior filings, and the hanging sisal twine 17. Olfactory stimulation is produced through the presence of an aromatic substance 18 on the interior region of the pet toy 80. Also, the pet toy 80 can provide auditory stimulation to the pet through the use of plurality of filings in the interior region.

However, the pet toy 80 provides a varied combination of visual stimulation. First, pet toy 80 has cat eyes 11 (similar to that in FIG. 1) and ear twine 71 (similar to that in FIGS. 7-10). Pet toy 80 further has a cat's nose 12, as well as looped fabric 13.

It should be noted that various changes and modifications to the presently preferred embodiments described herein will be apparent to those skilled in the art. Such changes and modifications may be made without departing from the spirit and scope of the present invention and without diminishing its attendant advantages.

What is claimed is:

1. A pet toy, comprising:
an outer looped fabric;
a pair of eyes and a nose;
an amount of catnip dispersed within the toy; and
a plurality of noisemakers dispersed within the toy.

2. The pet toy of claim 1, further comprising a first enclosure across the top of said pet toy.

3. The pet toy of claim 2, wherein said first enclosure is stitching across the top of said pet toy.

4. The pet toy of claim 2, wherein said first enclosure is shaped to form a pair of ears.

5. The pet toy of claim 1, further comprising a second enclosure at the bottom of said toy.

6. The pet toy of claim 5, wherein said second enclosure further comprising hanging fabric.

7. The pet toy of claim 6, wherein said hanging fabric is at least 3 inches long.

8. The pet toy of claim 6, wherein said second enclosure is formed with tied material.

9. The pet toy of claim 8, wherein said tied material is twine.

10. The pet toy of claim 9, wherein said twine extends at least 3 inches.

11. The pet toy of claim 1, wherein said pair of eyes comprise cat-shaped pupils.

12. The pet toy of claim 1, wherein said amount of catnip is enclosed within a breathable pouch.

13. The pet toy of claim 1, wherein said toy is at least twenty inches in total length, and approximately nine to eleven and one half inches in circumference.

14. The pet toy of claim 1, wherein said eyes and nose are positioned to form a face on said pet toy.

15. The pet toy of claim 1, wherein said plurality of noisemakers comprise at least one jingle bell and at least one segment of crackling paper.

16. The pet toy of claim 1, wherein said outer looped fabric covers entire pet toy.

17. The pet toy of claim 1, wherein a pair of ears are formed using tied material.

18. The pet toy of claim 17, wherein said tied material is twine.

19. The pet toy of claim 18, wherein said twine extends at least 3 inches.

20. The pet toy of claim 1, wherein said toy is used as a body pillow for pets.
